(19) United States
(12) Patent Application Publication
(10) Pub. No.: US 2023/0209683 A1
(43) Pub. Date: Jun. 29, 2023

(54) MULTIFUNCTIONAL CONTROL CIRCUIT FOR LED STRING LIGHTS

(71) Applicant: TAIZHOU HAIRUI DECORATION LIGHTS CO.LTD., Taizhou (CN)

(72) Inventors: Hailang Wang, Taizhou (CN); Huanyu Qu, Taizhou (CN)

(21) Appl. No.: 17/646,327

(22) Filed: Dec. 29, 2021

(51) Int. Cl. H05B 45/48; H05B 45/3725

(52) U.S. Cl. CPC H05B 45/48; H05B 45/3725

(57) ABSTRACT

The present invention discloses a multifunctional control circuit for LED string lights, and belongs to the technical field of LED lighting control. The control circuit is entirely powered by a power supply circuit, wherein a switch circuit is controlled by a master control circuit; a single-chip microcomputer switches corresponding control programs whenever it is detected that a function switching button is turned on, output level of a corresponding output interface of the single-chip microcomputer is controlled according to a corresponding control program, so that on/off control of the switch circuit is achieved, and control waveforms in the master control circuit are transmitted to controlled LED string lights to achieve stable control of the LED string lights. The multifunctional control circuit for LED string lights has the advantages of being simple in structure, reasonable in design, and stable in control.

### FIELD OF TECHNOLOGY

The present invention relates to the technical field of LED lighting control, and in particular relates to a multifunctional control circuit for LED string lights.

### BACKGROUND

The LED lighting product is formed by combining a plurality of LED bulbs in parallel, in series, or in series-parallel connection. In terms of light emitting colors, the LED string lights can be divided into monochromatic LED string lights, bi-color LED string lights, tri-color LED string lights and quad-color LED string lights. In terms of structure, the LED string lights can be divided into LED string lights without built-in ICs and LED string lights with built-in ICs. All of the above LED string lights, regardless of type, require a controller for control.

The control circuit is an important part of the controller, due to improper hardware design in the control circuit, an existing controller for LED string lights has the problems such as unstable control and inability to make the LED string lights with a built-in IC light up with a predetermined display effect.

Hence, how to research and develop a novel control circuit to solve above problems has become a problem urgent to be solved.

### SUMMARY

To this end, the present invention provides a multifunctional control circuit for LED string lights to improve control stability of a control circuit.

The technical solution provided by the present invention is specifically a multifunctional control circuit for LED string lights. The control circuit comprises a master control circuit, a switch circuit, and a power supply circuit;

wherein the master control circuit comprises a single-chip microcomputer and a function switching button;

one end of the function switching button is grounded, the other end of the function switching button is connected to a control input interface of the single-chip microcomputer, and the interior of the control input interface is pulled up to a high level; a control program is programmed in the single-chip microcomputer, and the control program in the single-chip microcomputer performs output level control whenever the function switching button is pressed for being turned on;

one end of the switch circuit is connected to one wiring terminal of controlled LED string lights, and the other end of the switch circuit is connected to an output interface of the single-chip microcomputer; and on/off of the switch circuit is controlled according to the output level of the output interface of the single-chip microcomputer; and

an output end of the power supply circuit is respectively connected to a power supply interface of the single-chip microcomputer and another wiring terminal of the controlled LED string lights to power the master control circuit and the controlled LED string lights.

Preferably, the switch circuit is composed of a NMOS field-effect transistor, a second resistor and a third resistor or is composed of a NPN triode, a second resistor and a third resistor;

when the switch circuit is composed of the NMOS field-effect transistor, the second resistor and the third resistor, a gate electrode of the NMOS field-effect transistor is connected to the output interface of the single-chip microcomputer after being connected to the third resistor in series, a source electrode of the NMOS field-effect transistor is grounded, and a drain electrode of the NMOS field-effect transistor is connected to one wiring terminal of the controlled LED string lights; one end of the second resistor is connected to one wiring terminal of the controlled LED string lights, and the other end of the second resistor is connected to another wiring terminal of the controlled LED string lights; and

when the switch circuit is composed of the NPN triode, the second resistor and the third resistor, a base electrode of the NPN triode is connected to the output interface of the single-chip microcomputer after being connected to the third resistor in series, an emitter electrode of the NPN triode is grounded, and a collector electrode of the NPN triode is connected to one wiring terminal of the controlled LED string lights; one end of the second resistor is connected to one wiring terminal of the controlled LED string lights, and the other end of the second resistor is connected to another wiring terminal of the controlled LED string lights.

Further preferably, the switch circuit is composed of an NMOS field-effect transistor and a second Zener diode, or is composed of a NPN triode and a second Zener diode;

when the switch circuit is composed of the NMOS field-effect transistor and the second Zener diode, a gate electrode of the NMOS field-effect transistor is connected to the output interface of the single-chip microcomputer, a source electrode of the NMOS field-effect transistor is grounded, and a drain electrode of the NMOS field-effect transistor is connected to one wiring terminal of the controlled LED string lights; a positive electrode of the second Zener diode is grounded, and a negative electrode of the second Zener diode is connected to the drain electrode of the NMOS field-effect transistor; and

when the switch circuit is composed of the NPN triode and the second Zener diode, a base electrode of the NPN triode is connected to the output interface of the single-chip microcomputer, an emitter electrode of the NPN triode is grounded, and a collector electrode of the NPN triode is connected to one wiring terminal of the controlled LED string lights; a positive electrode of the second. Zener diode is grounded, and a negative electrode of the second Zener diode is connected to the collector electrode of the NPN triode.

Further preferably, the switch circuit is composed of a fourth resistor, a fifth resistor, a sixth resistor, a seventh resistor, an eighth resistor, a ninth resistor, a first PNP triode, a first NPN triode, a second PNP triode, and a second NPN triode;

after one end of the fourth resistor is connected to one end of the fifth resistor in series, the other end of the fourth resistor is connected to the output end of the power supply circuit, and the other end of the fifth resistor is connected to one wiring terminal of the controlled LED string lights;

after one end of the sixth resistor is connected to one end of the seventh resistor in series, the other end of the sixth resistor is connected to an output end of the power supply circuit, and the other end of the seventh resistor is connected to another wiring terminal of the controlled LED string lights;

a base electrode of the first PNP triode is connected between the fourth resistor and the fifth resistor, a collector electrode of the first PNP triode is connected to one wiring terminal of the controlled LED string lights, and an emitter electrode of the first PNP triode is connected to the output end of the power supply circuit;

a base electrode of the first NPN triode is connected to one output interface of the single-chip microcomputer after being connected to the eighth resistor in series, a collector electrode of the first NPN triode is connected to one wiring terminal of the controlled LED string lights, and an emitter electrode of the first NPN triode is grounded;

a base electrode of the second PNP triode is connected between the sixth resistor and the seventh resistor, a collector electrode of the second PNP triode is connected to another wiring terminal of the controlled LED string lights, and an emitter electrode of the second PNP triode is connected to the output end of the power supply circuit; and

a base electrode of the second NPN triode is connected to another output interface of the single-chip microcomputer after being connected to the ninth resistor in series, a collector electrode of the second NPN triode is connected to another wiring terminal of the controlled LED string lights, and an emitter electrode of the second NPN triode is grounded.

Further preferably, the first PNP triode and the second PNP triode can both be replaced with the PMOS field-effect transistors, and the first NPN triode and the second NPN triode can both be replaced with NMOS field-effect transistors.

Further preferably, the single-chip microcomputer in the master control circuit is a single-chip microcomputer with a built-in EEPROM storage medium.

Further preferably, the master control circuit further comprises a first filter capacitor and a second filter capacitor;

after the first filter capacitor is connected to the second filter capacitor in parallel, one end of the first filter capacitor is connected to a power supply interface of the single-chip microcomputer, and the other end of the first filter capacitor is connected to a grounding, interface of the single-chip microcomputer.

Further preferably, the master control circuit further comprises a crystal oscillator, a third capacitor, and a fourth capacitor;

two ends of the crystal oscillator are connected to a clock interface of the single-chip microcomputer respectively;

one end of the third capacitor is connected to one end of the crystal oscillator, and the other end of the third capacitor is grounded; and

one end of the fourth capacitor is connected to the other end of the crystal oscillator, and the other end of the fourth capacitor is grounded.

Further preferably, the power supply circuit comprises a first diode, a dropping resistor, and a Zener diode;

a positive electrode of the first diode is connected to an external input power, and a negative electrode of the first diode is connected to another wiring terminal of the controlled LED string lights;

one end of the dropping resistor is connected to the negative electrode of the first diode, and the other end of the dropping resistor is connected to the power supply interface of the single-chip microcomputer; and

a positive electrode of the Zener diode is grounded, and a negative electrode of the Zener diode is connected to the other end of the dropping resistor.

A multifunctional control circuit for LED string lights provided by the present invention is entirely powered by a power supply circuit, wherein a switch circuit is controlled by a master control circuit; a single-chip microcomputer switches corresponding control programs whenever it is detected that a function switching button is turned on, output level of a corresponding output interface of the single-chip microcomputer is controlled according to a corresponding control program, so that on/off control of the switch circuit is achieved, and control waveforms in the master control circuit are transmitted to the controlled LED string lights to achieve stable control of the LED string lights.

The multifunctional control circuit for LED string lights has the advantages of being simple in structure, reasonable in design, and stable in control.

It should be understood that, the foregoing general description and the following detailed description are exemplary and explanatory only and are not restrictive of the disclosure of the present invention.

### BRIEF DESCRIPTION OF THE DRAWINGS

The accompanying drawings, which are incorporated in and constitute a part of this specification, illustrate embodiments conforming to the present invention and, and serve to explain the principles of the present invention together with the specification.

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a module diagram of a multifunctional control circuit for LED string lights provided by an embodiment of the disclosure of the present invention;

FIG. 2 is a circuit diagram of a master control circuit in a multifunctional control circuit for LED string lights provided by an embodiment of the disclosure of the present invention;

FIG. 3 is a circuit diagram of a first type of switch circuit in a multifunctional control circuit for LED string lights provided by an embodiment of the disclosure of the present invention;

FIG. 4 is a circuit diagram of a second type of switch circuit in a multifunctional control circuit for LED string lights provided by an embodiment of the disclosure of the present invention;

FIG. 5 is a circuit diagram of a third type of switch circuit in a multifunctional control circuit for LED string lights provided by an embodiment of the disclosure of the present invention;

FIG. 6 is a circuit diagram of a power supply circuit in a multifunctional control circuit for LED string lights provided by an embodiment of the disclosure of the present invention.

### DETAILED DESCRIPTION OF THE EMBODIMENTS

Exemplary embodiments will be described in detail herein, examples of which are represented in the accompanying drawings. Where the following description relates to the accompanying drawings, unless otherwise indicated, the same numerals in different accompanying drawings indicate the same or like elements. The embodiments described in the following exemplary embodiments do not represent all embodiments that are consistent with the present invention. In contrast, they are only examples of the devices that are consistent with some aspects of the present invention, as detailed in the appended claims.

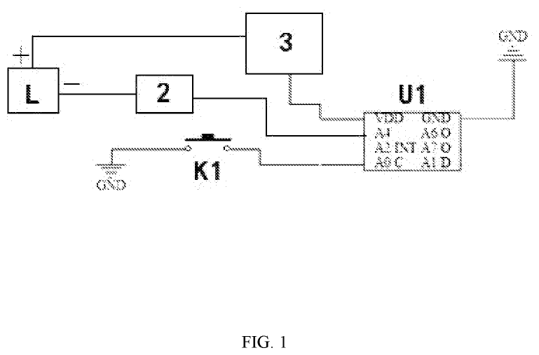

To solve the problem of poor control stability of the previous control circuit, referring to FIG. 1, the embodiment provides a multifunctional control circuit for LED string lights, the control circuit is mainly composed of a master control circuit 1, a switch circuit 2, and a power supply circuit 3, wherein the power supply circuit 3 is used for powering the master control circuit 1, the switch circuit 2, and controlled LED string lights L.

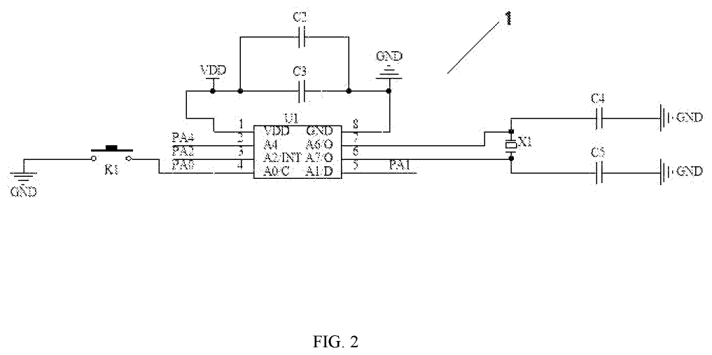

Referring to FIG. 2, the master control circuit 1 is mainly composed of a single-chip microcomputer U1 and a function switching button K1, wherein one end of the function switching button K1 is grounded, the other end of the function switching button is connected to a control input interface of the single-chip microcomputer U1, and the interior of the control input interface is pulled up to a high level; a control program is programmed in the single-chip microcomputer U1, and the control program in the single-chip microcomputer U1 performs output level control whenever the function switching button K1 is pressed for being turned on.

Referring to FIG. 1, one end of the switch circuit 2 is connected to one wiring terminal of the controlled LED string lights L, and the other end of the switch circuit is connected to an output interface of the single-chip microcomputer U1; and on/off of the switch circuit 2 is controlled according to the output level of the output interface of the single-chip microcomputer U1.

An output end of the power supply circuit 3 is respectively connected to a power supply interface of the single-chip microcomputer U1 and another wiring terminal of the controlled LED string lights L to power the master control circuit 1 and the controlled LED string lights L.

A specific working process of the multifunctional control circuit for LED string lights provided by the embodiment is as follows: the controller circuit is entirely powered by the power supply circuit, wherein the switch circuit is controlled by the master control circuit, and whenever the function switching button is turned on, a control input interface and the ground are conducted, and the control input interface is shifted to a low level from the high level; and therefore, the single-chip microcomputer can detect that the control input interface inputs the low level whenever the function switching button is turned on; at the moment, the single-chip microcomputer switches corresponding control programs, and output level of the output interface of the single-chip microcomputer is controlled according to the corresponding control program including whether the high level or the low level should be output, and the switching period between the high level and the low level, and the like, so that the on/off of the switch circuit is controlled, and control waveforms in the master control circuit are transmitted to the controlled LED string lights to make the LED string lights light up with a predetermined display effect, thus achieving stable control of the LED string lights.

The control programs programmed in the single-chip microcomputer U1 are all existing control programs, and corresponding control programs can be programmed in the single-chip microcomputer U1 according to actual functional needs of the LED string lights. To facilitate repeated erasures of the control program in the single-chip microcomputer U1 to meet different control needs, as an improvement of the technical solution, a single-chip microcomputer with a built-in EEPROM storage medium serves as above-mentioned single-chip microcomputer U1.

To cooperate with the implementation of different control functions, as an improvement of the technical solution, referring to FIG. 2, crystal oscillator related elements are further arranged in the master control circuit 1, specifically including: a crystal oscillator X1, a third capacitor C4, and a fourth capacitor C5, wherein two ends of the crystal oscillator X1 are connected to a clock interface of the single-chip microcomputer U1 respectively; one end of the third capacitor C4 is connected to one end of the crystal oscillator X1, and the other end of the third capacitor is grounded; and one end of the fourth capacitor C5 is connected to the other end of the crystal oscillator X1, and the other end of the fourth capacitor is grounded.

For the situation that the switch circuit 2 can be correspondingly provided with corresponding switch circuit structures according to the control needs of the controlled LED string lights, three types of switch circuits 2 with different structures are specifically provided by the embodiment, and specific structures of the three types of switch circuits 2 are illustrated below one by one.

1) For an LED String Light with the Controlled Voltage at Two Levels of 0V and vccV

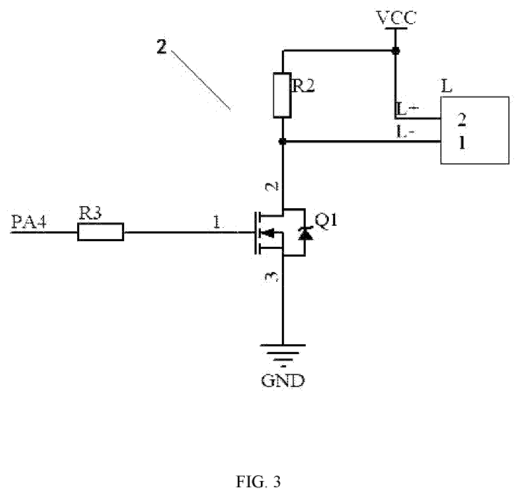

Referring to FIG. 3, the switch circuit 2 is composed of a NMOS field-effect transistor Q1, a second resistor R2, and a third resistor R3, or is composed of a NPN triode, a second resistor R2, and a third resistor R3.

When the switch circuit 2 is composed of the NMOS field-effect transistor Q1, the second resistor R2, and the third resistor R3, a gate electrode of the NMOS field-effect transistor Q1 is connected to the output interface of the single-chip microcomputer U1 after being connected to the third resistor R3 in series, a source electrode of the NMOS field-effect transistor Q1 is grounded, and a drain electrode of the NMOS field-effect transistor Q1 is connected to a negative wiring terminal of the controlled LED string lights L; and one end of the second resistor R2 is connected to a positive wiring terminal of the controlled LED string lights L, and the other end of the second resistor R2 is connected to the negative wiring terminal of the controlled LED string lights L to release residual electric energy in the controlled LED string lights L.

When the switch circuit 2 is composed of the NPN triode, the second resistor R2 and the third resistor R3, a base electrode of the NPN triode is connected to the output interface of the single-chip microcomputer U1 after being connected to the third resistor R3 in series, an emitter electrode of the NPN triode is grounded, and a collector electrode of the NPN triode is connected to a negative wiring terminal of the controlled LED string lights L; and one end of the second resistor R2 is connected to the positive wiring terminal of the controlled LED string lights L, and the other end of the second resistor R2 is connected to the negative wiring terminal of the controlled LED string lights L to release residual electric energy in the controlled LED string lights L.

In correspondence to the two types of switch circuits, the output ends of the power supply circuits 3 are all connected to the positive wiring terminal of the controlled LED string lights L.

The two types of switch circuits respectively take the NMOS field-effect transistor or the NPN triode as a control switch to achieve on/off of the circuit, with the specific working process as follows: when the output interface of the single-chip microcomputer U1 outputs a high level to the third resistor R3, the switch circuit 2 is turned on, so that the NMOS field-effect transistor/NPN triode is conducted, and the power supply circuit powers the LED string lights with a supply voltage of vccV; when the output interface of the single-chip microcomputer U1 outputs a low level to the third resistor R3, the switch circuit 2 is turned off, so that the NMOS field effect transistor/NPN triode is switched off and does not power the LED, string lights, the supply voltage is 0V, and then control waveform of vccV or 0V is sent to the LED string lights.

Due to the fact that an IC in the LED string lights with the built-in IC receives a carrier signal, and the carrier signal is high in frequency, the key physical factor for correctly receiving the carrier signal is whether the rising edge or the falling edge of the signal is steep enough; in above solution, the residual electric energy in the controlled LED string lights is released through the second resistor R2, so that the carrier signal is switched between vccV and 0V to achieve the correct receiving of the carrier signal by the LED string lights.

2) For the LED String Light with the Controlled Voltage at Two Levels of (vcc-n) V and vccV

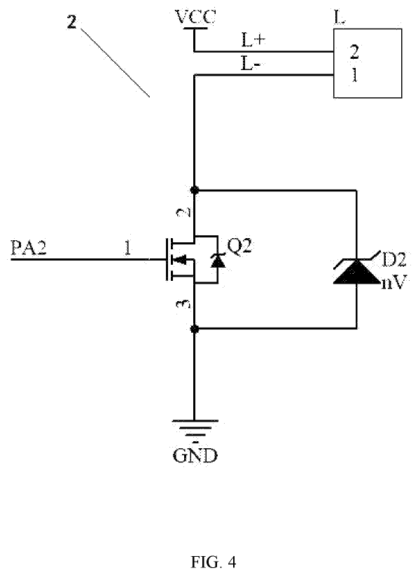

Referring to FIG. 4, the switch circuit 2 is composed of a NMOS field-effect transistor Q2 and a second Zener diode D2, or is composed of a NPN triode and a second Zener diode D2.

When the switch circuit 2 is composed of the NMOS field-effect transistor Q2 and the second Zener diode D2, a gate electrode of the NMOS field-effect transistor Q2 is connected to the output interface of the single-chip microcomputer U1, a source electrode of the NMOS field-effect transistor Q2 is grounded, and a drain electrode of the NMOS field-effect transistor Q2 is connected to the negative wiring terminal of the controlled LED string lights L; a positive electrode of the second Zener diode D2 is grounded, and a negative electrode of the second Zener diode D2 is connected to the drain electrode of the NMOS field-effect transistor.

When the switch circuit 2 is composed, of the NPN triode and the second Zener diode D2, a base electrode of the NPN triode is connected to the output interface of the single-chip microcomputer U1, an emitter electrode of the NPN triode is grounded, and a collector electrode of the NPN triode is connected to the negative wiring terminal of the controlled LED string lights L; a positive electrode of the second Zener diode D2 is grounded, and a negative electrode of the second Zener diode D2 is connected to the collector electrode of the NPN triode.

In correspondence to the two types of switch circuits, the output ends of the power supply circuits 3 are all connected to the positive wiring terminal of the controlled LED string lights L.

The two types of switch circuits respectively take the NMOS field-effect transistor or the NPN triode as a control switch to achieve on/off of the circuit, with the specific working process as follows: when the output interface of the single-chip microcomputer U1 outputs a high level, the switch circuit 2 is, turned on, so that the NMOS field-effect transistor/NPN triode is conducted, the negative voltage of the LED string lights is close to the ground voltage, and the voltage across the LED string lights is close to the vccV voltage; when the output interface of the single-chip microcomputer U1 outputs a low level, the switch circuit 2 is turned off, so that the NMOS field-effect transistor/the NPN triode is switched off, the negative voltage of the LED string lights is close to (nV) voltage of the second Zener diode D2, the voltage across the LED string lights is closed to the (vcc-n)V voltage, and then the control waveform of vccV or (vcc-n)V is sent to the LED string lights.

3) For the Switch Circuit Capable of Supply Forward Voltage or Negative Voltage to the LED String Lights

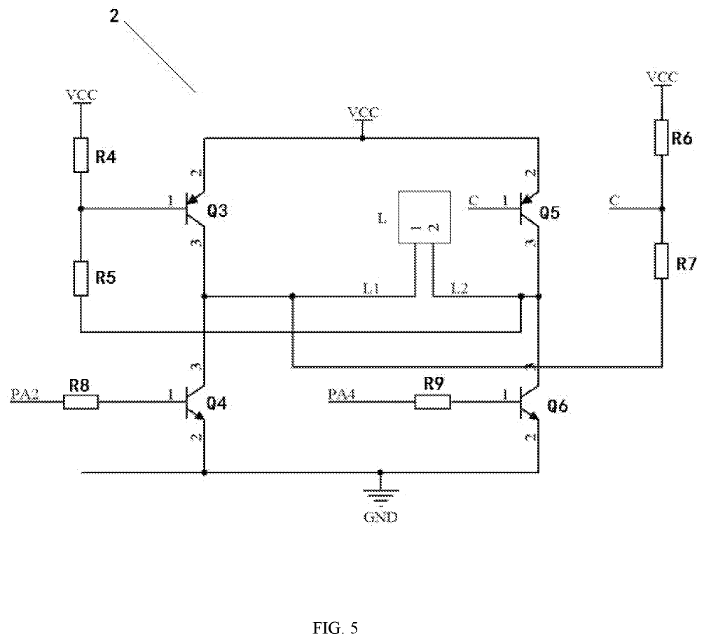

Referring to FIG. 5, the switch circuit 2 is composed of a fourth resistor R4, a fifth resistor R5, a sixth resistor R6, a seventh resistor R7, an eighth resistor R8, a ninth resistor R9, a first PNP triode Q3, a first NPN triode Q4, a second PNP triode Q5, and a second NPN triode Q6.

Wherein after one end of the fourth resistor R4 is connected to one end of the fifth resistor R5 in series, the other, end of the fourth resistor R4 is connected to the output end of the power supply circuit 3, and the other end of the fifth, resistor R5 is connected to an L2 wiring terminal of the controlled LED string lights L;

after one end of the sixth resistor R6 is connected to one end of the seventh resistor R7 in series, the other end of the sixth resistor R6 is connected to an output end of the power supply circuit 3, and the other end of the seventh resistor R7 is connected to an L1 wiring terminal of the controlled LED string lights L;

a base electrode of the first PNP triode Q3 is connected between the fourth resistor R4 and the fifth resistor R5, a collector electrode of the first PNP triode Q3 is connected to the L1 wiring terminal of the controlled LED string lights L, and an emitter electrode of the first PNP triode Q3 is connected to the output end of the power supply circuit 3;

a base electrode of the first NPN triode Q4 is connected to one output interface PA2 of the single-chip microcomputer U1 after being connected to the eighth resistor R8 in series, a collector electrode of the first NPN triode Q4 is connected to the L1 wiring terminal of the controlled LED string lights L, and an emitter electrode of the first NPN triode Q4 is grounded;

a base electrode of the second PNP triode Q5 is connected between the sixth resistor R6 and the seventh resistor R7, a collector electrode of the second PNP triode Q5 is connected to the L2 wiring terminal of the controlled LED string lights L, and an emitter electrode of the second PNP triode Q5 is connected to the output end of the power supply circuit 3; and

a base electrode of the second NPN triode Q6 is connected to an output interface PA4 of the single-chip microcomputer U1 after being connected to the ninth resistor R9 in series, a collector electrode of the second NPN triode Q6 is connected to the L2 wiring terminal of the controlled LED string lights L, and an emitter electrode of the second NPN triode Q6 is grounded.

At the moment, when the PA2 output interface of the single-chip microcomputer U1 is at a high level and the PA4 output interface of the single-chip microcomputer is at a low level, the first NPN, triode Q4 is conducted, the base voltage of the second PNP triode Q5 is lower than vccV and the second PNP triode Q5 is also conducted, so that a power supply direction of the controlled LED string lights L is that the L2 voltage is larger than the L1 voltage, i.e., the LED string lights L is conducted forwardly; when the PA4 output interface of the single-chip microcomputer U1 is at a high level and the PA2 output interface of the single-chip microcomputer is at a low level, the second NPN triode Q6 is conducted, the base voltage of the first PNP triode Q3 is lower than vccV and the first PNP triode Q3 is also conducted, so that a power supply direction of the LED string lights L is that the L1 voltage is larger than the L2 voltage, i.e., the LED string lights L is conducted negatively.

To achieve above functions, the first PNP triode Q3 and the second PNP triode Q5 can both be replaced with PMOS field-effect transistors, and the first NPN triode Q4 and the second NPN triode Q6 can both be replaced with NMOS field-effect transistors. After replacement, connecting positions of a gate electrode, a drain electrode and a source electrode of the PMOS field-effect transistor are in one-to-one correspondence to connecting positions of a base electrode, a collector electrode and an emitter electrode of the PNP triode respectively, and connecting positions of a gate electrode, a drain electrode and a source electrode of the NMOS field-effect transistor are in one-to-one correspondence to connecting positions of a base electrode, a collector electrode and an emitter electrode of the NPN triode respectively.

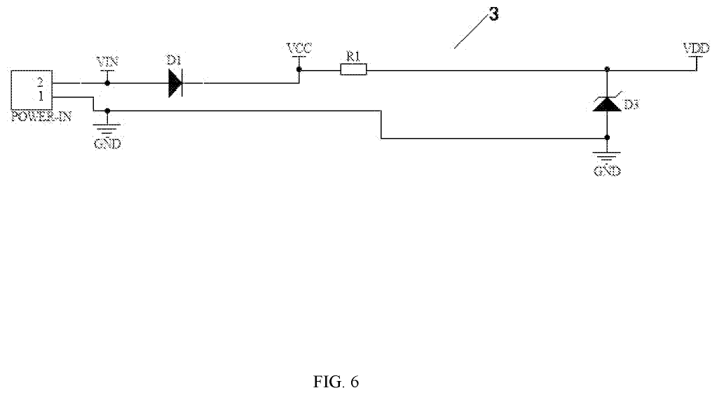

To achieve two functions of anti-reverse plugging and voltage dropping with the least number of components, as an improvement of the technical solution, referring to FIG. 6, the power supply circuit 3 is mainly composed of a first diode D1, a dropping resistor R1 and a Zener diode D3, wherein a positive electrode of the first diode D1 is connected to an external input power, and a negative electrode of the first diode D1 is connected to a negative electrode of the LED string lights L; one end of the dropping resistor R1 is connected to the negative electrode of the first diode D1, and the other end of the dropping resistor is connected to the power supply interface of the single-chip microcomputer U1; and a positive electrode of the Zener diode D3 is grounded, and the negative electrode of the Zener diode is connected to the other end of the dropping resistor R1.

A Schottky diode serves as the power supply circuit through the first diode, on the one hand, the input voltage VIN is slightly reduced as the power supply voltage vcc of the controlled LED string lights L to meet a current requirement of the controlled LED string lights L; on the other hand, the Schottky diode also has a function of preventing reverse power supply to protect the controlled LED string lights L. The power supply voltage VDD of the single-chip microcomputer U1 is obtained after the power supply voltage vcc is reduced by the dropping resistor R1 and then stabilized by the Zener diode D3.

As a further improvement of the technical solution, referring to FIG. 2, the master control circuit 1 further comprises a first filter capacitor C2 and a second filter capacitor C3, wherein, after the first filter capacitor C2 is connected to the second filter capacitor C3 in parallel, one end of the first filter capacitor is connected to a power supply interface of the single-chip microcomputer U1, and the other end of the first filter capacitor is connected to a grounding interface of the single-chip microcomputer U1, so that the power supply voltage VDD is input to the single-chip microcomputer U1 for power supply after being filtered.

Other embodiments of the invention will readily come to the mind of those skilled in the art upon consideration of the specification and practice of the present invention disclosed herein. This application is intended to cover any variations, uses, or adaptations of the present invention, which follow the general principles of the present invention and include common general knowledge or conventional technical means in the technical field to which the present invention is not, disclosed. The specification and embodiments are considered exemplary only, and the true scope and spirit of the present invention is indicated by the following claims.

It should be understood that the present invention is not limited to precise structures which have been described above and illustrated in the accompanying drawings, and that various modifications and changes may be made without departing from its scope. The scope of the present invention is only limited by the appended claims.

What is claimed is:

1. A multifunctional control circuit for LED string lights, comprising a master control circuit (1), a switch circuit (2), and a power supply circuit (3);
wherein the master control circuit (1) comprises a single-chip microcomputer (U1) and a function switching button (K1);
one end of the function switching button (K1) is grounded, the other end of the function switching button is connected to a control input interface of the single-chip microcomputer (U1), and the interior of the control input interface is pulled up to a high level; a control program is programmed in the single-chip microcomputer (U1), and the control program in the single-chip microcomputer (U1) performs output level control whenever the function switching button (K1) is pressed for being turned on;
one end of the switch circuit (2) is connected to one wiring terminal of a controlled LED string lights (L), and the other end of the switch circuit is connected to an output interface of the single-chip microcomputer (U1); and on/off of the switch circuit (2) is controlled according to the output level of the output interface of the single-chip microcomputer (U1); and
an output end of the power supply circuit (3) is respectively connected to a power supply interface of the single-chip microcomputer (U1) and another wiring terminal of the controlled LED string lights (L) to power the master control circuit (1) and the controlled LED string lights (L); wherein
the switch circuit (2) is composed of a NMOS field-effect transistor (Q1), a second resistor (R2) and a third resistor (R3), or is composed of a NPN triode, a second resistor (R2) and a third resistor (R3); when the switch circuit (2) is composed of the NMOS field-effect transistor (Q1), the second resistor (R2) and the third resistor (R3), a gate electrode of the NMOS field-effect transistor (Q1) is connected to the output interface of the single-chip microcomputer (U1) after being connected to the third resistor (R3) in series, a source electrode of the NMOS field-effect transistor (Q1) is grounded, and a drain electrode of the NMOS field-effect transistor (Q1) is connected to one wiring terminal of the controlled LED string lights (L); one end of the second resistor (R2) is connected to one wiring terminal of the controlled LED string lights (L), and the other end of the second resistor is connected to another wiring terminal of the controlled LED string lights (L); when the switch circuit (2) is composed of the NPN triode, the second resistor (R2) and the third resistor (R3), a base electrode of the NPN triode is connected to the output interface of the single-chip microcomputer (U1) after being connected to the third resistor (R3) in series, an emitter electrode of the NPN triode is grounded, and a collector electrode of the NPN triode is connected to one wiring terminal of the controlled LED string lights (L); one end of the second resistor (R2) is connected to one wiring terminal of the controlled LED string lights (L), and the other end of the second resistor is connected to another wiring terminal of the controlled LED string lights (L);
or
the switch circuit (2) is composed of an NMOS field-effect transistor (Q2) and a second Zener diode (D2), or is composed of a NPN triode and a second Zener diode (D2); when the switch circuit (2) is composed of the NMOS field-effect transistor (Q2) and the second Zener diode (D2), a gate electrode of the NMOS field-effect transistor (Q2) is connected to the output interface of the single-chip microcomputer (U1), a source electrode of the NMOS field-effect transistor (Q2) is grounded, and a drain electrode of the NMOS field-effect transistor (Q2) is connected to one wiring terminal of the controlled LED string lights (L); a positive electrode of the second Zener diode (D2) is grounded, and a negative electrode of the second Zener diode (D2) is connected to the drain electrode of the NMOS field-effect transistor (Q2); when the switch circuit (2) is composed of the NPN triode and the second Zener diode (D2), a base electrode of the NPN triode is connected to the output interface of the single-chip microcomputer (U1), an emitter electrode of the NPN triode is grounded, and a collector electrode of the NPN triode is connected to one wiring terminal of the controlled LED string lights (L); a positive electrode of the second Zener diode (D2) is grounded, and a negative electrode of the second Zener diode (D2) is connected to the collector electrode of the NPN triode;
or
the switch circuit (2) is composed of a fourth resistor (R4), a fifth resistor (R5), a sixth resistor (R6), a seventh resistor (R7), an eighth resistor (R8), a ninth resistor (R9), a first PNP triode (Q3), a first NPN triode (Q4), a second PNP triode (Q5), and a second NPN triode (Q6); after one end of the fourth resistor (R4) is connected to one end of the fifth resistor (R5) in series, the other end of the fourth resistor (R4) is connected to the output end of the power supply circuit (3), and the other end of the fifth resistor (R5) is connected to one wiring terminal of the controlled LED string lights (L); after one end of the sixth resistor (R6) is connected to one end of the seventh resistor (R7) in series, the other end of the sixth resistor (R6) is connected to an output end of the power supply circuit (3), and the other end of the seventh resistor (R7) is connected to another wiring terminal of the controlled LED string lights (L); a base electrode of the first PNP triode (Q3) is connected between the fourth resistor (R4) and the fifth resistor (R5), a collector electrode of the first PNP triode (Q3) is connected to one wiring terminal of the controlled LED string lights (L), and an emitter electrode of the first PNP triode (Q3) is connected to the output end of the power supply circuit (3); a base electrode of the first NPN triode (Q4) is connected to one output interface of the single-chip microcomputer (U1) after being connected to the eighth resistor (R8) in series, a collector electrode of the first NPN triode (Q4) is connected to one wiring terminal of the controlled LED string lights (L), and an emitter electrode of the first NPN triode (Q4) is grounded; a base electrode of the second PNP triode (Q5) is connected between the sixth resistor (R6) and the seventh resistor (R7), a collector electrode of the second PNP triode (Q5) is connected to another wiring terminal of the controlled LED string lights (L), and an emitter electrode of the second PNP triode (Q5) is connected to the output end of the power supply circuit (3); and a base electrode of the second NPN triode (Q6) is connected to another output interface of the single-chip microcomputer (U1) after being connected to the ninth resistor (R9) in series, a collector electrode of the second NPN triode (Q6) is connected to another wiring terminal of the controlled LED string lights (L), and an emitter electrode of the second NPN triode (Q6) is grounded.

2-4. (canceled)

5. The multifunctional control circuit for LED string lights according to claim 1, wherein the first PNP triode (Q3) and the second PNP triode (Q5) can both be replaced with the PMOS field-effect transistors, and the first NPN triode (Q4) and the second NPN triode (Q6) can both be replaced with NMOS field-effect transistors.

6. The multifunctional control circuit for LED string lights according to claim 1, wherein the single-chip microcomputer (U1) in the master control circuit (1) is a single-chip microcomputer with a built-in EEPROM storage medium.

7. The multifunctional control circuit for LED string lights according to claim 1, wherein the master control circuit (1) further comprises a first filter capacitor (C2) and a second filter capacitor (C3);
after the first filter capacitor (C2) is connected to the second filter capacitor (C3) in parallel, one end of the first filter capacitor is connected to a power supply interface of the single-chip microcomputer (U1), and the other end of the first filter capacitor is connected to a grounding interface of the single-chip microcomputer (U1).

8. The multifunctional control circuit for LED string lights according to claim 1, wherein the master control circuit (1) further comprises a crystal oscillator (X1), a third capacitor (C4), and a fourth capacitor (C5);
two ends of the crystal oscillator (X1) are connected to a clock interface of the single-chip microcomputer (U1) respectively;
one end of the third capacitor (C4) is connected to one end of the crystal oscillator (X1), and the other end of the third capacitor is grounded;
one end of the fourth capacitor (C5) is connected to the other end of the crystal oscillator (X1), and the other end of the fourth capacitor is grounded.

9. The multifunctional control circuit for LED string lights according to claim 1, wherein the power supply circuit (3) comprises a first diode (D1), a dropping resistor (R1), and a Zener diode (D3);
a positive electrode of the first diode (D1) is connected to an external input power, and a negative electrode of the first diode (D1) is connected to another wiring terminal of the controlled LED string lights (L);
one end of the dropping resistor (R1) is connected to the negative electrode of the first diode (D1), and the other end of the dropping resistor is connected to the power supply interface of the single-chip microcomputer (U1);
a positive electrode of the Zener diode (D3) is grounded, and a negative electrode of the Zener diode is connected to the other end of the dropping resistor (R1).
